(19) United States
(12) Patent Application Publication
(10) Pub. No.: US 2008/0187052 A1
(43) Pub. Date: Aug. 7, 2008

(54) VIDEO CODING DEVICE, VIDEO RECORDING DEVICE, VIDEO CODING METHOD, AND VIDEO CODING PROGRAM

(76) Inventors: Kengo TERADA, Osaka (JP); Ryuya HOSHINO, Osaka (JP); Koji NAKAJIMA, Kyoto (JP)

Correspondence Address: MCDERMOTT WILL & EMERY LLP, 600 13TH STREET, NW, WASHINGTON, DC, 20005-3096, US

(21) Appl. No.: 12/026,034

(22) Filed: Feb. 5, 2008

(30) Foreign Application Priority Data
Feb. 5, 2007 (JP) 2007-025835

(51) Int. Cl. H04N 7/12

(52) U.S. Cl. 375/240.24; 375/E07.176

(57) ABSTRACT

A block dividing section divides a video frame into plural pieces of block data of a predetermined size and outputs the plural pieces block data sequentially. A block coding section codes the block data. A coding amount computing section computes a coding margin amount on the basis of a coding generation amount in the block coding section. A distance computing section computes a block distance indicating a distance between an arbitrary point of fixation predetermined in the video frame and to-be-coded block data. When a coding amount insufficiency determining section determines that the coding margin amount is smaller than an insufficiency threshold value and a coding suppression determining section determines that the block distance is larger than a distance threshold value, a coding amount suppressing section suppresses the coding generation amount in the block coding section according to the coding suppression amount.

### BACKGROUND OF THE INVENTION

The present invention relates to a device and a method for coding a video frame, and particularly relates to a technique for controlling a coding amount (rate control).

Recent remarkable progress in technology of digital image appliances increases occasions to compress and code a video signal (a plurality of video frames arranged in time sequence) input from a video camera or a TV tuner to record them into a recording medium, such as a DVD, a hard disk, or the like. For coding a video signal, it is desired to maintain a desired coding rate. In order to adjust the coding rate, there is employed a method called two-pass coding, in which after coding a video signal and analyzing a characteristic thereof, the coded video signal is decoded, and then, a coding parameter is adjusted on the basis of the analysis result of the video signal for coding again the video signal.

It is difficult, however, to perform real-time processing of the video signal by the two-pass coding because time required for coding is rather limited. In view of this, a method called one-pass coding (for example, MPEG 2 test model cited in Non-patent Document 1 (ISO-IEC JTC1/SC29/WG11: Test Mdel5, 1993)) has been employed in many cases.

Herein, a conventional video coding device will be described briefly. This video coding device inputs a plurality of video frames sequentially and codes each video frame in a block unit of a predetermined size. In block data coding, there are performed orthogonal transform to a frequency component, quantization using a quantization scale, inter-frame predictive coding, motion compensation, and the like. Further, the video coding device computes a quantization scale on the basis of a coding generation amount in the block data coding and codes the next block data with the use of the thus computed quantization scale to thus perform rate control so that the coding generation amount satisfies a desired coding rate. In the quantization scale computation, the smaller the coding margin amount (a value obtained by subtracting an actual coding generation amount from an upper limit value of the coding generation amount obtained from the coding rate) is, the larger a quantization coefficient indicated in the quantization scale is.

In the conventional video coding device, however, a dynamic image where the motion of video content indicated in the image signal is active causes lasting of insufficient coding margin amount to increase the quantization coefficient indicated in the quantization scale. This degrades the image quality over the entire image in each video frame, thereby leading to observable degradation in image quality of the video frames.

### SUMMARY OF THE INVENTION

In view of the foregoing, the present invention has its object of controlling a code generation amount so as to satisfy a desired coding rate while suppressing observable degradation in image quality of video frames.

In the present invention, when the coding margin amount is insufficient, processing for suppressing a coding generation amount is performed on each block data located in a region apart from an arbitrary point of fixation predetermined in a video frame. In video frames, the farther from the point of fixation the block data is, the less observable degradation in image quality is. Accordingly, while the image quality is degraded in a region apart from the point of fixation, the image quality is maintained in the vicinity of the point of fixation of the video frame with no degradation caused. Thus, degradation in image quality of the video frames is less observable than the conventional one.

A video coding device in one aspect of the present invention is a video coding device for sequentially coding a plurality of video frames, which includes: a block dividing section which divides a video frame into plural pieces of block data of a predetermined size and outputs the plural pieces of block data sequentially; a block coding section which codes the block data from the block dividing section; a coding amount computing section which computes a coding margin amount on the basis a coding generation amount in the block coding section so that the coding generation amount satisfies a predetermined coding rate; a coding amount insufficiency determining section which determines whether or not the coding margin amount computed by the coding amount computing section is smaller than an insufficiency threshold value; a distance computing section which computes a block distance indicating a distance between an arbitrary point of fixation predetermined in the video frame and to-be-processed block data to be processed by the block coding section; a coding suppression determining section which determines whether or not the block distance computed by the distance computing section is larger than a distance threshold value; and a coding amount suppressing section which suppresses, when the coding amount insufficiency determining section determines that the coding margin amount is smaller than the insufficiency threshold value and the coding suppression determining section determines that the block distance is larger than the distance threshold value, the coding generation amount in the block coding section according to a coding suppression amount indicating an extent that the coding generation amount is to be suppressed.

In the above video coding device, when the coding margin amount is insufficient, processing for suppressing a coding generation amount is performed on each block data belonging to a region apart from the arbitrary point of fixation predetermined in the video frame. This enables control of the coding generation amount for satisfying the coding generation amount to be at a desired coding rate while degradation in image quality of the video frames becomes less observable.

Referring to another aspect of the present invention, a video recording device includes: the above video coding device; an input section which provides the video frame to the video coding device; and a recording section which records the code string from the video coding device to a recording medium.

The above picture recoding device can record an image signal in real time and permits degradation in image quality of the video signal to be less observable.

A video coding method in still another aspect of the present invention is a method for sequentially coding a plurality of video frames, which includes the steps of: (a) dividing a video frame into plural pieces of block data of a predetermined size; (b) outputting any one of the plural pieces of block data generated in the step (a); (c) coding the block data output in the step (b); (d) computing a coding margin amount on the basis of a coding generation amount in the step (c) so that the coding generation amount satisfies a desired coding rate; (e) determining whether or not the coding margin amount computed in the step (d) is smaller than an insufficiency threshold value; (f) outputting to-be-coded block data out of the plural pieces of block data generated in the step (a); (g) computing a block distance indicating a distance between an arbitrary point of fixation predetermined in the video frame and the block data output in the step (f); (h) determining whether or not the block distance computed in the step (g) is larger than a distance threshold value; and (i) performing, when it is determined in the step (e) that the coding margin amount is smaller than the insufficiency threshold value and it is determined in the step (h) that the block distance is larger than the distance threshold value, processing for suppressing the coding generation amount and then coding the block data output in the step (f).

### BRIEF DESCRIPTION OF THE DRAWINGS

FIG. 1 is a block diagram showing a whole configuration of a video coding device in accordance with Embodiment 1 of the present invention.

FIG. 2 is a block diagram showing an internal configuration of a block coding section shown in FIG. 1.

FIG. 3 is a flowchart depicting operation of the video coding device (a coding amount insufficiency determining section, a distance computing section, and a coding suppression amount computing section) shown in FIG. 1.

FIG. 4 is a flowchart depicting operation of the video coding device (a coding suppression determining section) shown in FIG. 1.

FIG. 5 is a flowchart depicting operation of the video coding device (a quantization scale correcting section) shown in FIG. 1.

FIG. 6 is a diagram for explaining computation of a block distance.

FIG. 7 is a diagram for explaining an aspect where a coding suppression amount is changed according to the block distance.

FIG. 8 is a diagram for explaining an aspect where the range of a coding suppression region is changed according to a coding margin amount.

FIG. 9 is a diagram for explaining an aspect where the range of the coding suppression region is changed according to a picture type.

FIG. 10 is a block diagram showing a modified example of the video coding device shown in FIG. 1.

FIG. 11 is a flowchart depicting processing by the coding suppression determining

section shown in FIG. 10.

FIG. 12 is a block diagram showing an internal configuration of a block coding section in accordance with Embodiment 2 of the present invention.

FIG. 13 is a block diagram showing an internal configuration of a motion compensation processing section shown in FIG. 12.

FIG. 14A and FIG. 14B are diagrams for explaining processing by a minor coefficient discarding section shown in FIG. 12.

FIG. 15A and FIG. 15B are diagrams for explaining processing of an inter-range coefficient discarding section shown in FIG. 12.

FIG. 16A and FIG. 16B are diagrams for explaining processing of a flame-limiting motion compensating section shown in FIG. 13.

FIG. 17 is a block diagram showing a whole configuration of a video recording device in accordance with Embodiment 3 of the present invention.

### DESCRIPTION OF THE PREFERRED EMBODIMENTS

Preferred embodiments of the present invention will be described below in detail with reference to the accompanying drawings. The same reference numerals are assigned to the same or corresponding functional elements in the drawings for avoiding repetition of description thereof.

### Embodiment 1

<Whole Configuration>

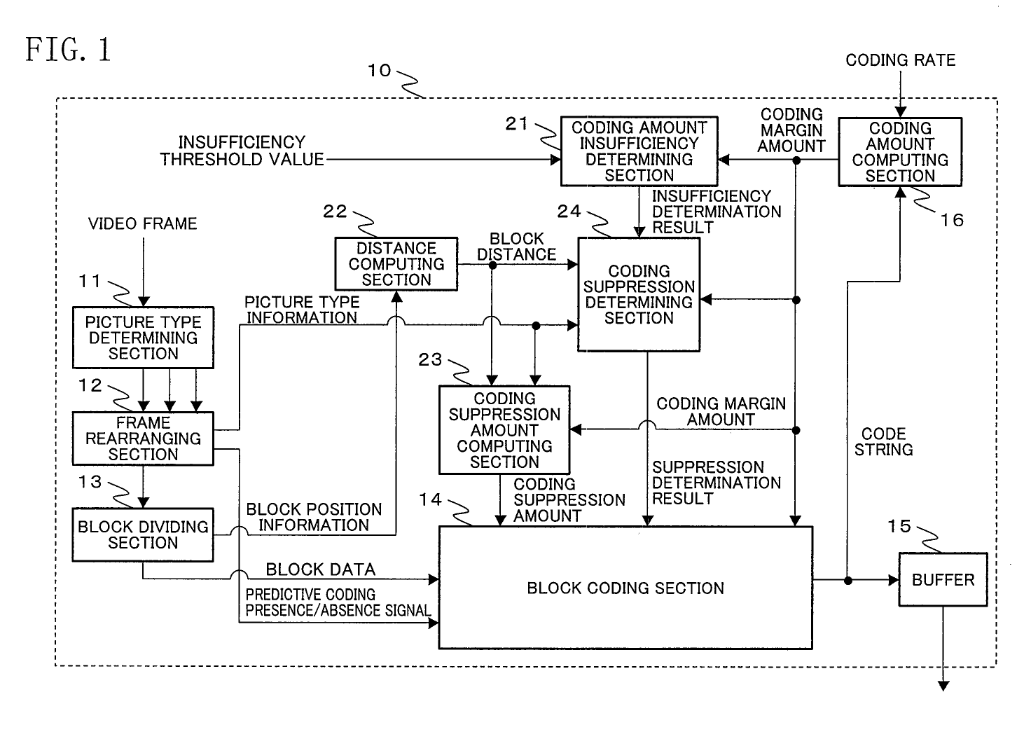

FIG. 1 shows a whole configuration of a video coding device in accordance with Embodiment 1 of the present invention. This video coding device 10 codes sequentially a plurality of video frames arranged in time sequence and performs rate control so that the coding generation amount satisfies a desired coding rate. The video coding device 10 includes a picture type determining section 11, a frame rearranging section 12, a block dividing section 13, a block coding section 14, a buffer 15, a coding amount computing section 16, a coding amount insufficiency determining section 21, a distance computing section 22, a coding suppression mount computing section 23, and a coding suppression determining section 24.

The picture type determining section 11 inputs sequentially a plurality of video frames arranged in time sequence. The picture type determining section 11 determines which picture type an input video frame belongs to, I picture type, P picture type, or B picture type, determines whether or not inter-frame predictive coding is necessary for the input video frame, and determines whether the inter-frame predictive coding of the video frame uses a past video frame or a future video frame. Further, the picture type determining section 11 outputs the input video frame, picture type information indicating the thus determined picture type of the video frame, and a predictive coding presence/absence signal for the video frame. The predictive coding presence/absence signal includes information indicating whether or not inter-frame predictive coding is necessary and information indicating which frame inter-frame predictive coding uses, a past video frame or a future video frame.

The frame rearranging section 12 inputs sequentially the video frames from the picture type determining section 11 and the picture type information and the predictive coding presence/absence signal for the respective video frames. The frame rearranging section 12 rearranges the plurality of video frames arranged in time sequence into a coding sequence on the basis of the picture type information. For example, when a future video frame (a video frame to be input to the frame rearranging section 12 after a currently input video frame) is necessary for coding the currently input video frame, the frame rearranging section 12 rearranges the sequence of the video frames so that the future video frame is coded prior to the currently input video frame. Then, the frame rearranging section 12 outputs the video frames in the coding sequence (outputs the video frames to be coded) together with the picture type information and the predictive coding presence/absence signal for the respective video frames.

The block dividing section 13 inputs sequentially the video frames from the frame rearranging section 12. The block dividing section 13 divides a currently input video frame into plural pieces of block data of a predetermined size. Further, the block dividing section 13 outputs sequentially the divided plural pieces of block data together with block position information indicating the current position of the corresponding block data in the corresponding video frame.

The block coding section 14 receives the block data from the block dividing section 13 and the predictive coding presence/absence signal from the frame rearranging section 12. The block coding section 14 performs orthogonal transform, quantization, inter-frame predictive coding, motion compensation, and code string conversion, and the like on the block data to convert the block data to a code string and then outputs it.

The buffer 15 receives the code string from the block coding section 14. The buffer 15 stores temporally the received code string and outputs it at a fixed rate or a variable rate.

The coding amount computing section 16 computes a coding generation amount in the block coding section 14, that is, an amount of code strings generated by the block coding section 14. The coding amount computing section 16 also computes a coding margin amount on the basis of the coding generation amount so that the coding generation amount in the block coding section 14 satisfies a desired coding rate. The coding margin amount is a value obtained by subtracting an actual coding generation amount from an upper limit of the coding generation amount obtained from the coding rate. The larger the coding generation amount in the block coding section 14 is, the smaller the coding margin amount computed by the coding amount computing section 16 is.

<Internal Configuration of Block Coding Section>

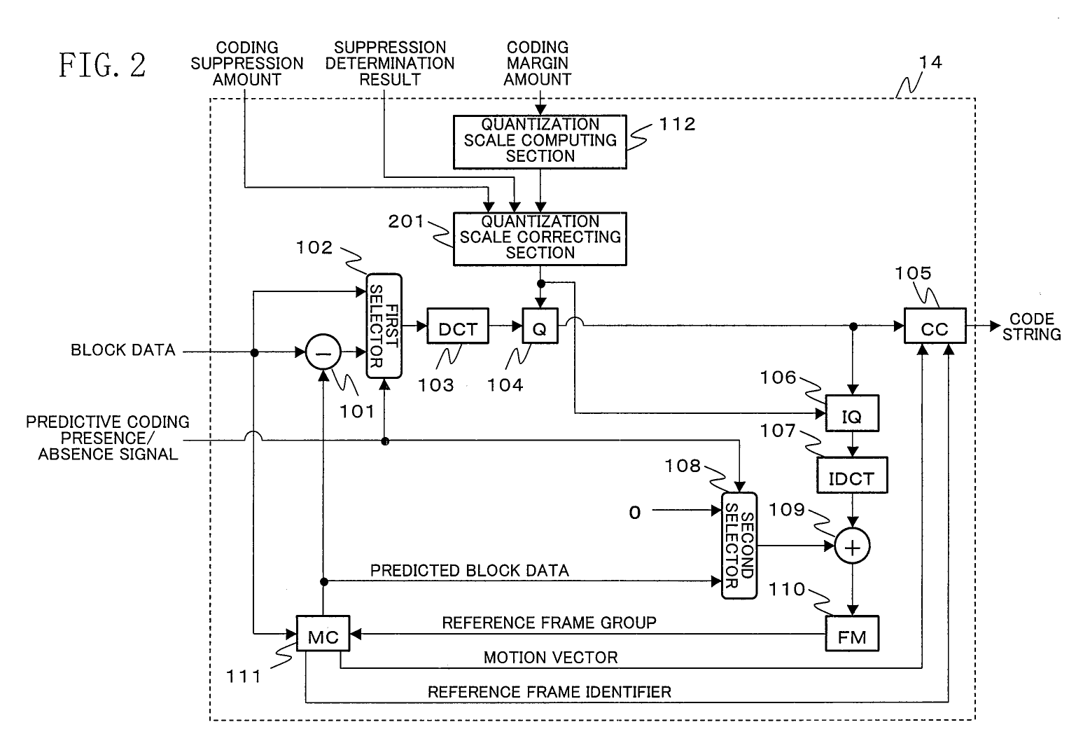

FIG. 2 shows an internal configuration of the block coding section 14 shown in FIG. 1. The block coding section 14 includes a subtractor 101, a first selector 102, an orthogonal transform performing section (DCT) 103, a quantizing section (Q) 104, a code string converting section (CC) 105, an inverse quantizing section (IQ) 106, an inverse orthogonal transform performing section (IDCT) 107, a second selector 108, an adder 109, a frame memory (FM) 110, a motion compensating section (MC) 111, a quantization scale computing section 112, and a quantization scale correcting section 201.

The subtractor 101 computes a difference between the block data from the block dividing section 13 and the block data (the predicted block data) from the motion compensating section 111 and outputs the computation result as predicted error block data.

The first selector 102 selects the block data from the block dividing section 13 when the predictive coding presence/absence signal indicates that inter-frame predictive coding is unnecessary while on the other hand selects the predicted error block data from the subtractor 101 when the predictive coding presence/absence signal indicates that inter-frame predictive coding is necessary.

The orthogonal transform performing section 103 performs orthogonal transform (discrete cosine transform, for example) on the block data selected by the first selector 102. Specifically, the orthogonal transform performing section 103 transforms the pixel coefficient indicated in the block data to an orthogonal transform coefficient (a coefficient indicating a frequency component).

The quantizing section 104 quantizes the block data subjected to orthogonal transform by the orthogonal transform performing section 103 with the use of a quantization scale. Specifically, the quantizing section 104 divides the coefficient indicated in the block data from the orthogonal transform performing section 103 by the quantization coefficient indicated in the quantization scale and outputs the division result as quantized block data.

The code string converting section 105 converts, for example, entropy-codes the block data quantized by the quantizing section 104, and a motion vector and a reference frame identifier from the motion compensating section 111 to a code string of variable or fixed length.

The inverse quantizing section 106 performs inverse quantization on the block data quantized by the quantizing section 104 with the use of the quantization scale.

The inverse orthogonal transform performing section 107 performs inverse orthogonal transform (for example, inverse discrete cosine transform) on the block data subjected to inverse quantization by the inverse quantizing section 106.

The second selector 108 selects “0” when the predictive coding presence/absence signal indicates that inter-frame predictive coding is unnecessary while on the other hand selects the predicted block data from the motion compensating section 111 when the predictive coding presence/absence signal indicates that inter-frame predictive coding is necessary.

The adder 109 adds the block data subjected to inverse orthogonal transform by the inverse orthogonal transform performing section 107 and the block data (or “0”) selected by the second selector 108 together. Whereby, the block data before orthogonal transform and quantization is reconstructed. The adder 109 outputs the reconstructed block data.

The frame memory 110 stores the block data from the adder 109 and generates a reference frame (a video frame that another video frame references in motion compensation) with the use of plural pieces of block data (the reconstructed block data). The frame memory 110 also stores a reference frame group of a plurality of reference frames.

The motion compensating section 111 receives the block data (to-be-processed block data) from the block dividing section 13 and the reference frame group stored in the frame memory 110. The motion compensating section 111 detects from the reference frame group a piece of block data with the highest similarly to the to-be-processed block data and outputs the detected block data as predicted block data to the subtractor 101 and the second selector 108. The motion compensating section 111 also outputs to the code string converting section 105 a reference frame identifier for identifying a reference frame including the predicted block data and a motion vector indicating a movement of an object from the to-be-processed block data to the predicted block data. The reference frame identifier indicates the referencing direction of the video frame (to-be-processed frame) including the to-be-processed block data and the number of frames from the to-be-processed video frame to the reference frame including the predicted block data. The larger the number of frames indicated in the reference frame identifier is, the larger the coding amount of the reference frame identifier is.

The quantization scale computing section 112 computes a quantization scale corresponding to -the coding margin amount computed by the coding amount computing section 16. For example, the quantization scale computing section 112 sets the quantization coefficient indicated in the quantization scale large as the coding margin amount is large. The quantization scale computed by the quantization scale computing section 112 is output to the quantizing section 104 and the inverse quantizing section 106 via the quantization scale correcting section 201.

<Motion Compensation>

Herein, motion compensation by the motion compensating section 111 will be described. The referencing scheme employable in motion compensation includes field referencing, frame referencing, bidirectional referencing, one-way referencing, and variable block size referencing.

(1) Field referencing: A method in which to-be-processed block data is divided to even-numbered lines and odd-numbered lines, a reference frame is divided also to even-numbered lines and odd-numbered lines, and the predicted block data and a motion vector are computed with the use of both the even-numbered lines and both the odd-numbered lines. The predicted block data and the motion vector may be computed by alternatively using the even-numbered lines and the odd-numbered lines.

(2)Frame referencing: A method in which predicted block data and a motion vector are computed with the use of to-be-processed block data and a reference frame without dividing the to-be-processed block and the reference frame to even-numbered lines and the odd-numbered lines. The number of motion vectors to be computed is smaller than that in the field referencing.

(3)Bidirectional referencing: A method in which an average image of a past video frame and a future video frame is used as a reference frame.

(4)One-way referencing: A method in which one of a past video frame and a future video frame is used as a reference frame. The number of motion vectors to be computed is smaller than that in the bidirectional referencing.

(5)Size variable block referencing: A method in which to-be-processed block data is further divided into plural pieces of small block data, and predicted block data and a motion vector of each piece of small block data are computed. The number of divisions is variable. For example, when the number of divisions is “eight” (in the case of eight-block block referencing), eight motion vectors are computed for each piece of to-be-processed data. The larger the number of division is, the larger the number of motion vectors to be computed is.

In the case where the field referencing, the bidirectional referencing, and eight-block block referencing are employed in combination (eight-block bidirectional field referencing), motion vectors are computed by dividing to-be-processed block data and reference frames into odd-numbered lines and even-numbered lines with the use of past and future video frames as the reference frames. This necessitates four-time (=2×2) prediction. Further, since the number of division is “eight,” 32 (=4×8) motion vectors are computed for one piece of to-be-processed data.

<Operation>

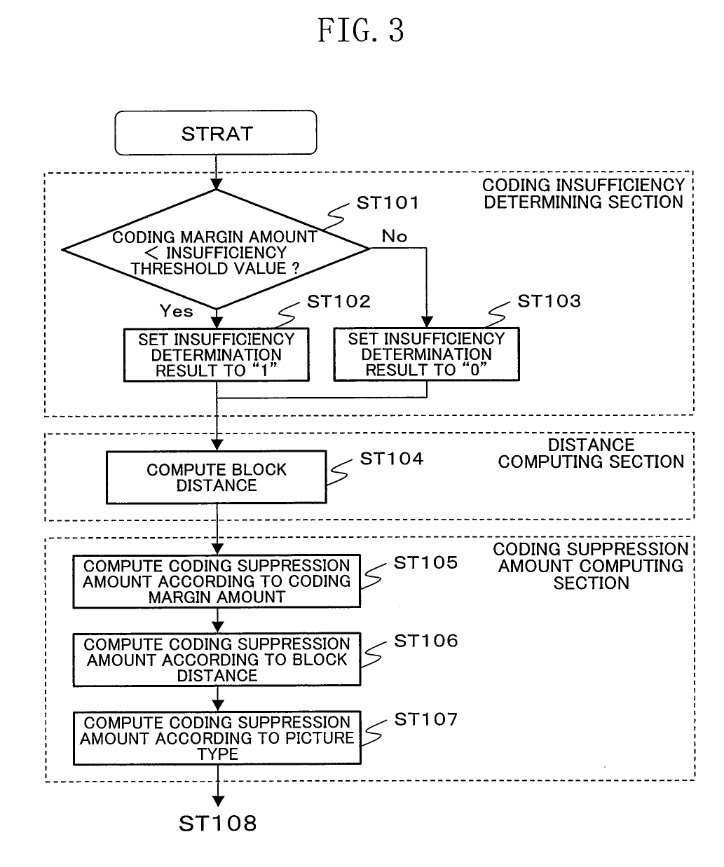

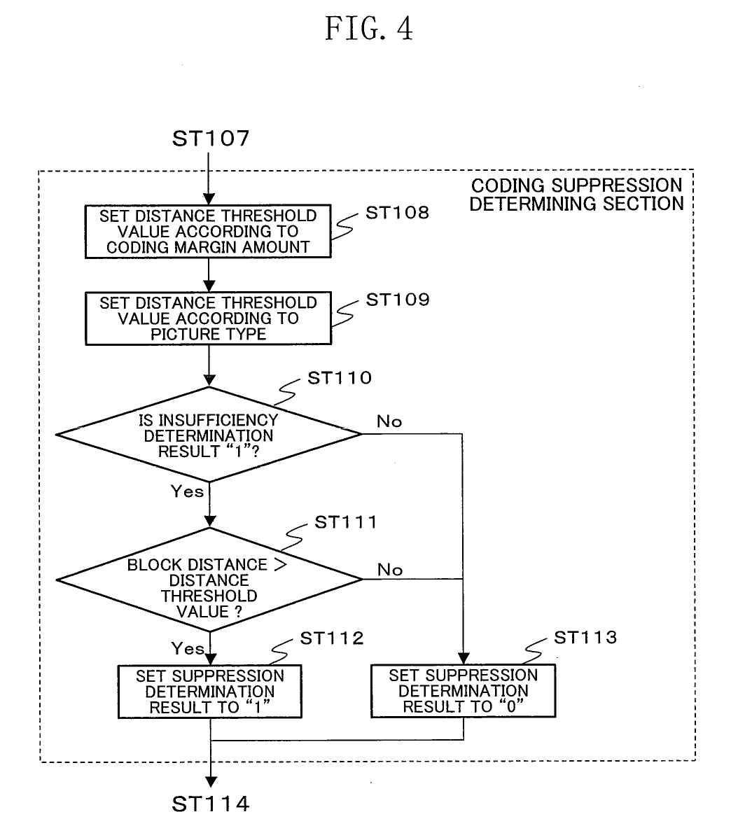

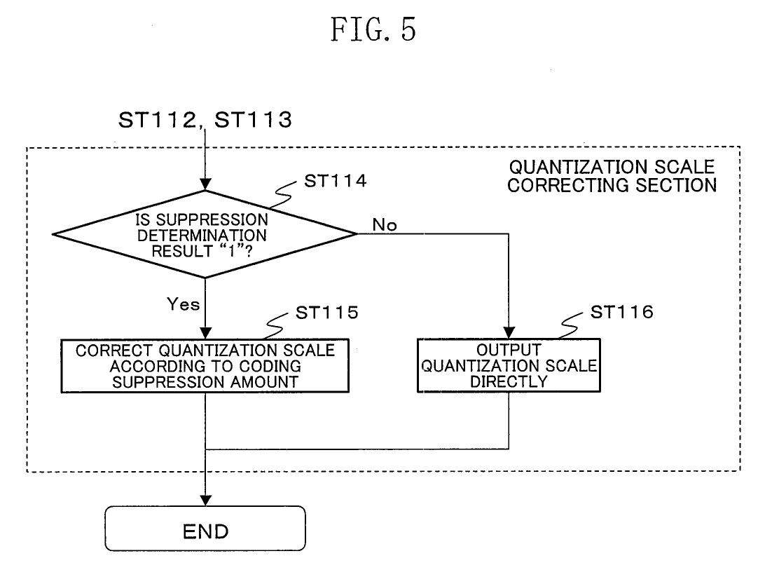

Rate control by the video coding device 10 shown in FIG. 1 will be described next with reference to FIG. 3, FIG. 4, and FIG. 5. The rate control is executed in parallel to coding by the block coding section 14. Herein, description will focus on each processing of the coding amount insufficiency determining section 21, the distance computing section 22, the coding suppression amount computing section 23, the coding suppression determining section 24, and the quantization scale correcting section 201.

[Step ST101]

First, the block coding section 14 codes block data, and the coding amount computing section 16 computes a coding margin amount on the basis of the coding generation amount in the block coding section 14. The coding amount insufficiency determining section 21 receives the coding margin amount computed by the coding amount computing section 16 and compares the thus received coding margin amount with an insufficiency threshold value. When the coding margin amount is smaller than the insufficiency threshold value, the routine proceeds to a step ST102. Otherwise, it proceeds to a step ST103.

[Step ST102]

Next, the coding amount insufficiency determining section 21 sets the insufficiency determination result to “1” (true) and informs the coding suppression determining section 24 that the coding margin amount is insufficient. Then, the routine proceeds to a step ST104.

[Step ST103]

When the coding margin amount is equal to or larger than the insufficiency threshold value in the step ST101, the coding amount insufficiency determining section 21 sets the insufficiency determination result to “0” (false) and informs the coding suppression determining section 24 that the coding margin amount is sufficient. Then, the routine proceeds to the step ST104.

[Step ST104]

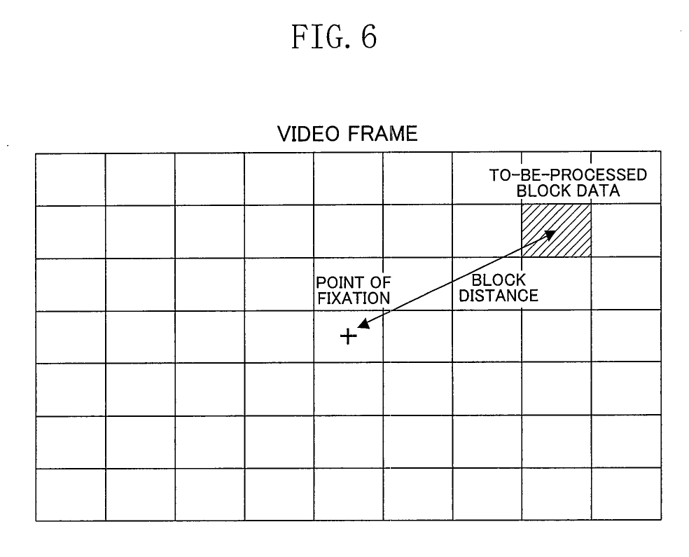

The block dividing section 13 outputs block data to be coded next by the block coding section 14 together with block position information of the block data (to-be-processed block data). The distance computing section 22 computes on the basis of the block position information from the block dividing section 13 a block distance indicating the distance between an arbitrary point of fixation predetermined in the video frame (the center point of the video frame herein) and the to-be-processed block data. Referring to the case shown in FIG. 6, for example, the block distance of the to-be-processed block data is computed as “5.”

[Step ST105]

The coding suppression amount determining section 23 receives the coding margin amount computed by the coding amount computing section 16. The coding suppression amount computing section 23 computes the coding suppression amount according to the thus received coding margin amount so that the coding suppression amount is large as the coding margin amount is small. The coding suppression amount is information indicating an amount that the coding generation amount in the block coding section 14 should be suppressed. For example, the coding suppression amount computing section 23 sets, as the coding suppression amount, a value obtained by multiplying the reciprocal of the coding margin amount by a coding suppression amount conversion coefficient A (A≧1).

[Step ST106]

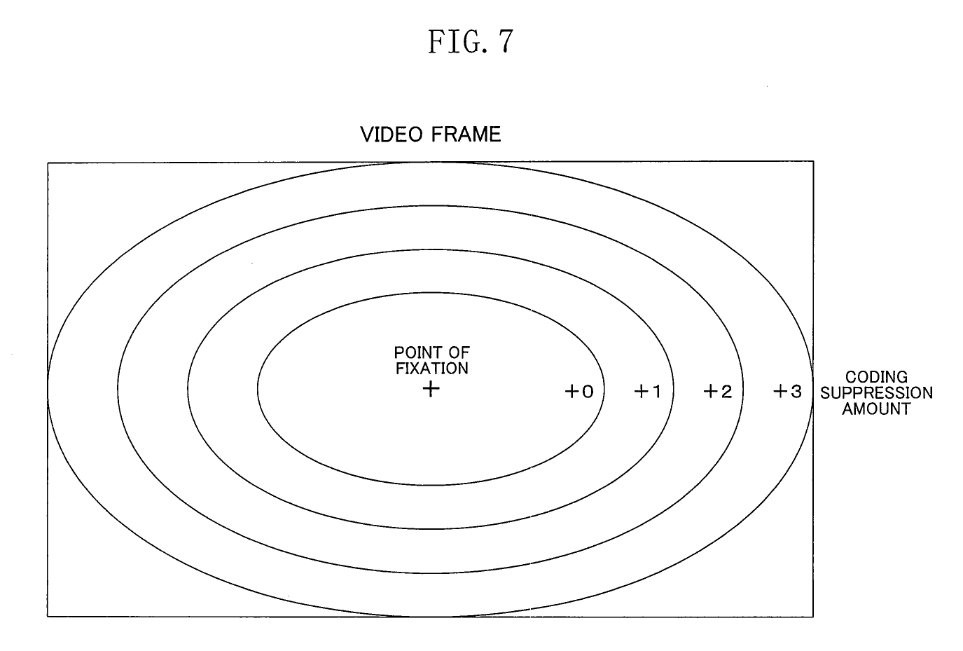

The coding suppression amount computing section 23 also receives the block distance computed by the distance computing section 22. The coding suppression amount computing section 23 computes the coding suppression amount according to the thus received block distance so that the coding suppression amount is large as the block distance is large. For example, the coding suppression amount computing section 23 adds a value obtained by multiplying the block distance by a coding suppression amount conversion coefficient B (B≧1) to the coding suppression amount computed in the step ST105. Whereby, the coding suppression amount is large as the block data is far from the point of fixation, as shown in FIG. 7.

[Step ST107]

The coding suppression amount computing section 23 further receives the picture type information from the frame rearranging section 12. The coding suppression amount computing section 23 computes the coding suppression amount according to the picture type indicated in the thus received picture type information so that the coding suppression amount becomes larger in order of I-picture type, P-picture type, and B-picture type. For example, the coding suppression amount computing section 23 adds “0” to the coding suppression amount when the video frame is of I-picture type, adds a reference image suppression coefficient C1(C1≧1) to the coding suppression amount when the video frame is of P-picture type, and adds a reference image suppression coefficient C2 (C2>C1) to the coding suppression amount when the video frame is of B-picture type.

[Step ST108]

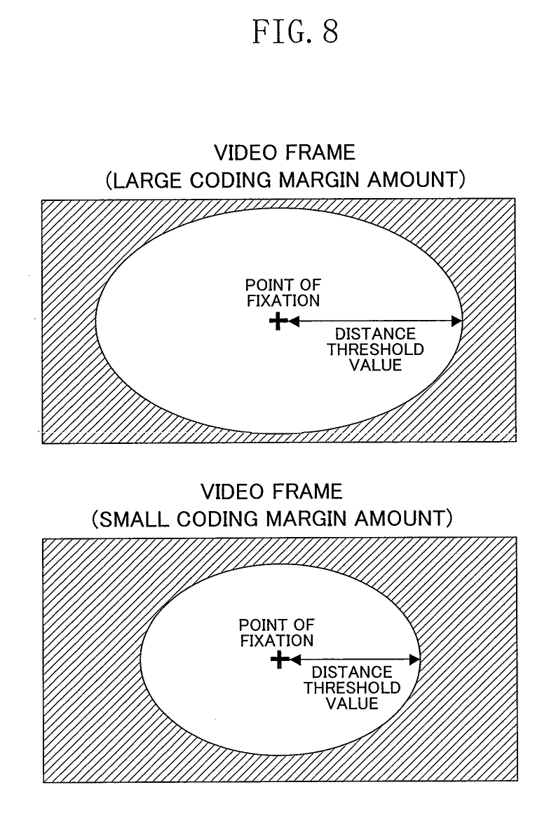

The coding suppression determining section 24 receives the coding margin amount computed by the coding amount computing section 16. The coding suppression determining section 24 sets a distance threshold value according to the coding margin amount so that the distance threshold value is small as the coding margin amount is small. The distance threshold value is a reference value for determining a coding suppression region (a region to which a block data of which coding generation amount is to be suppressed belongs) in a video frame. As shown in FIG. 8, the smaller the coding margin amount is, the wider the range of the coding suppression region (a hatched region in FIG. 8) is in the video frame.

[Step ST 109]

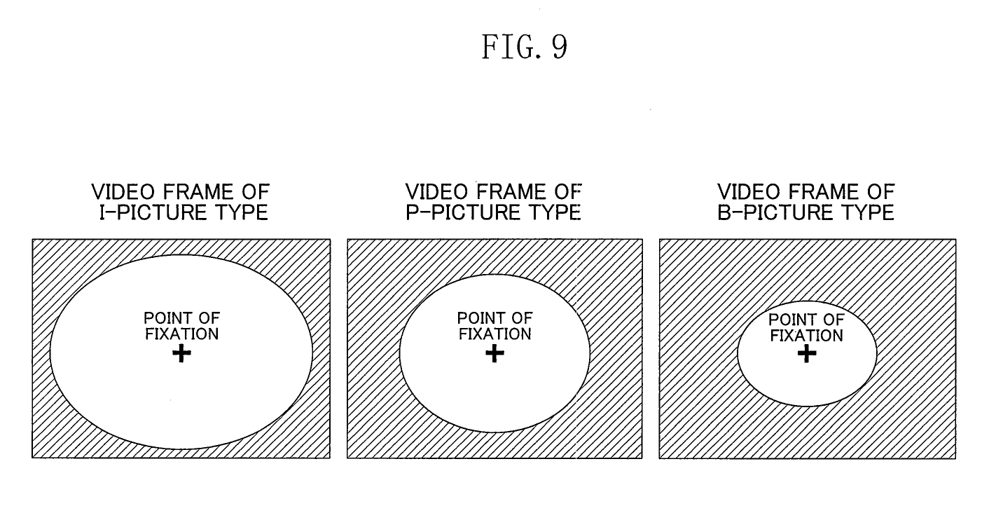

The coding suppression determining section 24 also receives the picture type information from the frame rearranging section 12. The coding suppression determining section 24 sets the distance threshold value according to the picture type indicated in the thus received picture type information so that the distance threshold value becomes smaller in order of I-picture type, P-picture type, and B-picture type. As shown in FIG. 9, the coding suppression region ranges wider in order of I-picture type, P-picture type, and B-picture type.

[Step ST110]

Next, the coding suppression determining section 24 confirms the insufficiency determination result from the coding amount insufficiency determining section 21. When the insufficiency determination result is “1” (true), the routine proceeds to a step ST 111. On the other hand, when the insufficiency determination result is “0” (false), the routine proceeds to a step ST113.

[Step ST111]

The coding suppression determining section 24 compares the block distance computed by the distance computing section 22 with the distance threshold value. When the block distance is larger than the distance threshold value, the routine proceeds to a step ST112. On the other hand, when the block distance is equal to or smaller than the distance threshold value, the routine proceeds to the step ST113.

[Step ST112]

The coding suppression determining section 24 sets the suppression determination result to “1” (true) to inform the quantization scale correcting section 201 included in the block coding section 14 that suppression is necessary. Then, the routine proceeds to a step ST114.

[Step ST113]

On the other hand, when the insufficiency determination result is “0” (false) in the step ST110, or when the block distance is equal to or smaller than the distance threshold value in the step ST111, the coding suppression determining section 24 sets the suppression determination result to “0” (false) to inform the quantization scale correcting section 201 included in the block coding section 14 that suppression is unnecessary. Then, the routine proceeds to the step ST114.

[Step ST114]

Subsequently, the quantization scale correcting section 201 in the block coding section 14 confirms the suppression determination result from the coding suppression determining section 24. When the suppression determination result is “1” (true), the routine proceeds to a step ST115. On the other hand, when the suppression determination result is “0” (false), the routine proceeds to a step ST116.

[Step ST115]

The quantization scale correcting section 201 receives the quantization scale computed by the quantization scale computing section 112 and the coding suppression amount computed by the coding suppression amount computing section 23. The quantization scale correcting section 201 adds a predetermined value according to the coding suppression amount to the quantization coefficient indicated in the quantization scale so that the quantization coefficient indicated in the quantization scale is large as the coding suppression amount is large. For example, the quantization scale correcting section 201 sets a value to be added to the quantization coefficient in the quantization scale to be large as the coding suppression amount is large. The quantization scale correcting section 201 then outputs the thus corrected quantization scale to the quantizing section 104 and the inverse quantizing section 106.

[Step ST116]

When the suppression determination result is “0” (false) in the step ST114, the quantization scale correcting section 201 outputs the quantization scale computed by the quantization scale computing section 112 directly to the quantizing section 104 and the inverse quantizing section 106.

As described above, by increasing the quantization coefficient in the quantization scale, the coefficient indicated in the block data from the quantizing section 104 becomes smaller than that when a quantization scale computed by the quantization scale computing section 112 is used directly. Accordingly, the coding amount of the code string generated by the code string converting section 105 becomes small to suppress the coding generation amount in the block coding section 14.

<Effects>

When the coding margin amount is insufficient, the coding generation amount is suppressed for to-be-processed block data located in a region apart from an arbitrary point of fixation in a video frame while not being suppressed for to-be-processed block data located in a region near the point of fixation. Accordingly, the image quality is not degraded in the region near the point of fixation to make degradation in image quality of the video fame to be less observable when compared with the conventional case. Thus, the coding generation amount can be controlled so as to satisfy a desired coding rate and degradation in image quality of video frames is less observable.

Further, change in coding suppression amount according to the coding margin amount avoids excessive suppression of the coding generation amount to suppress excessive degradation in image quality of a video frame.

Change in the coding suppression amount according to the block distance increases the coding suppression amount gradually as the block data is located far from the point of fixation. This permits variation in image quality of a video flame to be less observable.

Moreover, change in the coding suppression amount according to the picture type of a video frame reduces degradation in image quality of a video fame serving as a reference frame. This reduces degradation in image quality of a video frame that references the reference frame.

Change in range of the coding suppression region according to the coding margin amount suppresses excessive widening of the range where the image is degraded to thus avoid excessive degradation in image quality of a video frame.

Furthermore, change in range of the coding suppression region according to the picture type of a video frame reduces degradation in image quality of a video frame that references a reference frame.

It is noted that the coding rate and the insufficiency threshold value may be fixed values or values changeable by external control. For example, the coding rate and the insufficiency threshold value may be set according to a characteristic of video frames (content of a video or the like).

In addition, the point of fixation may not be necessarily set at the center of a video frame. For example, the point of fixation may be set at any arbitrary point of a specific object in a video frame or any arbitrary point specified by the user.

(Modified Example)

The coding suppression amount may be a fixed value. In other words, computation of the coding suppression amount by the coding suppression amount computing section 23 (ST105, ST106, and ST107) can be omitted. To do so, the quantization scale correcting section 201 adds, when the suppression determination result is “1” (true), the fixed value to the quantization coefficient in the quantization scale computed by the quantization scale computing section 112.

The distance threshold value may be a fixed value. In other words, setting of the distance threshold value by the coding suppression determining section 24 (ST108 and ST109) can be omitted.

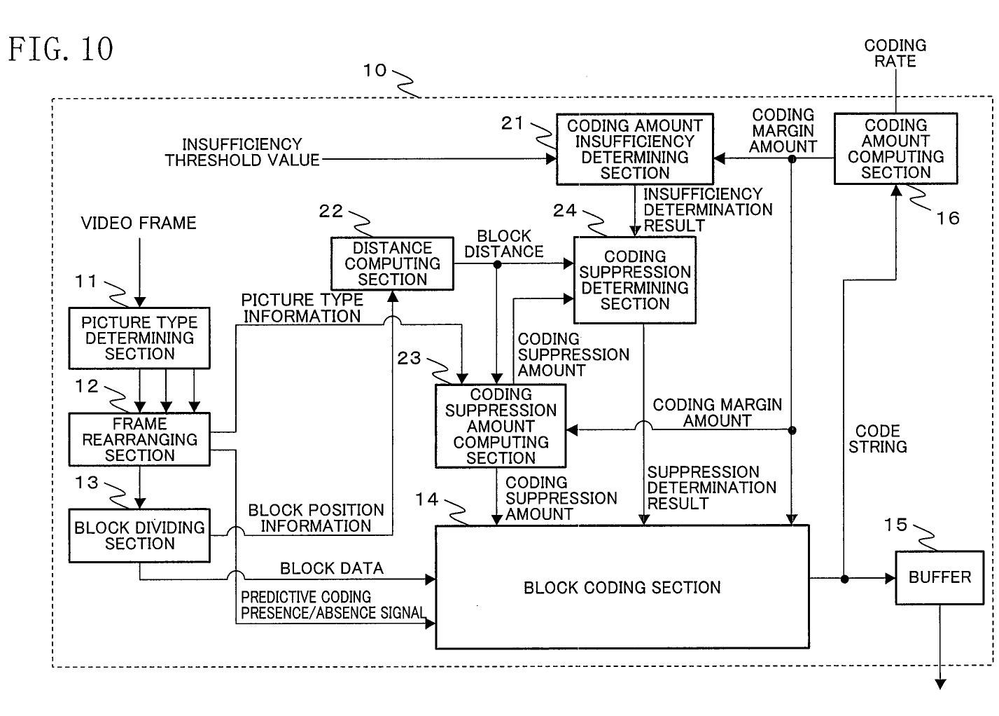

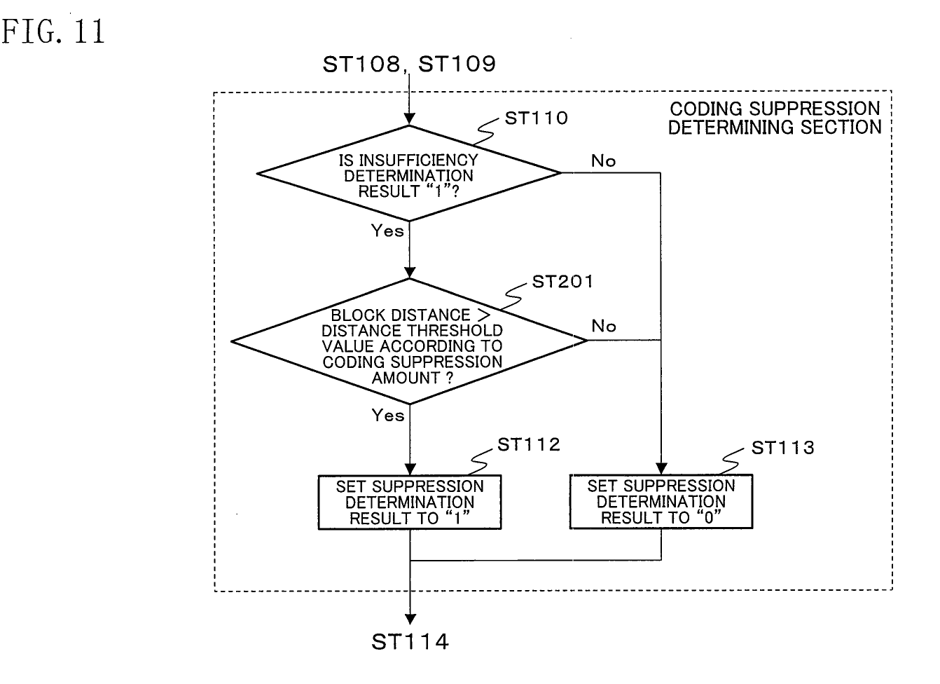

Further, as shown in FIG. 10, the coding suppression determining section 24 may receive the coding suppression amount computed by the coding suppression amount computing section 23 rather than the coding margin amount computed by the coding amount computing section 16 and the picture type information from the frame rearranging section 12. In this case, as shown in FIG. 11, the coding suppression determining section 24 performs the following processing (ST201) rather than the steps ST109 to ST111.

[Step ST201]

The coding suppression determining section 24 receives the coding suppression amount computed by the coding suppression amount computing section 23. The coding suppression determining section 24 corrects the distance threshold value to be compared with the block distance so that the distance threshold value is small as the coding suppression amount is large. For example, the coding suppression determining section 24 sets a value obtained, as the distance threshold value, by multiplying the reciprocal of the coding suppression amount by a distance conversion coefficient E (E>0) and compares the block distance with the thus corrected distance threshold value. When the block distance is larger than the distance threshold value, the routine proceeds to the step ST112. On the other hand, when the block distance is equal to or smaller than the distance threshold value, the routine proceeds to the step ST113.

### Embodiment 2

<Whole Configuration>

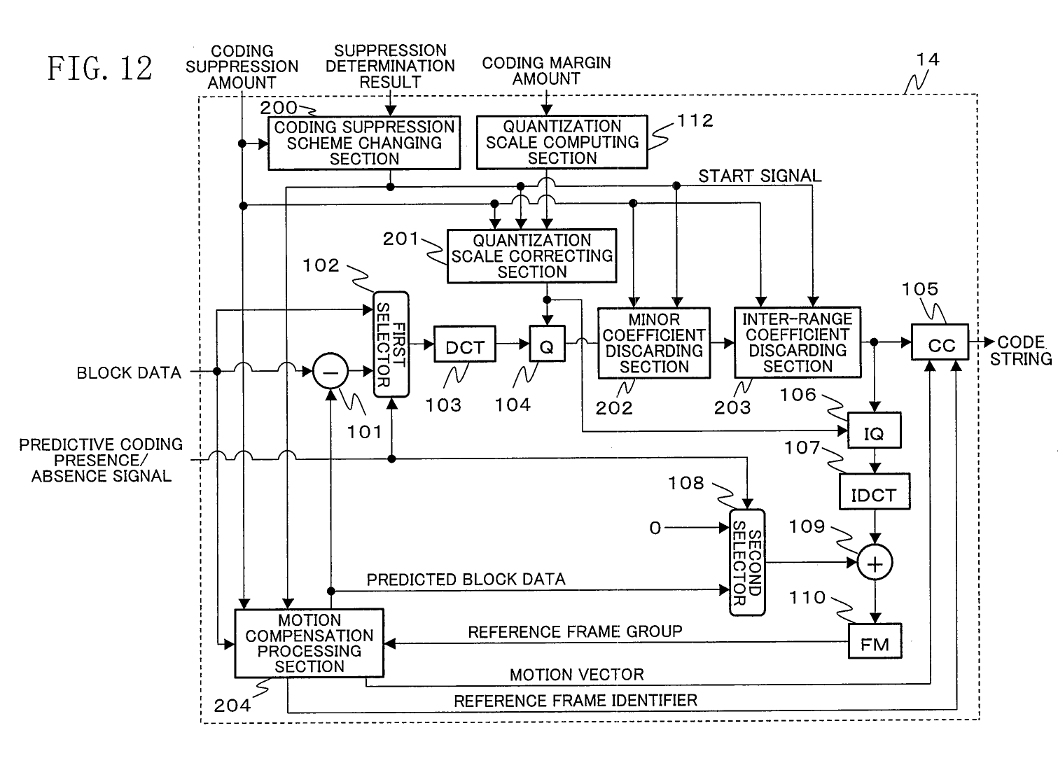

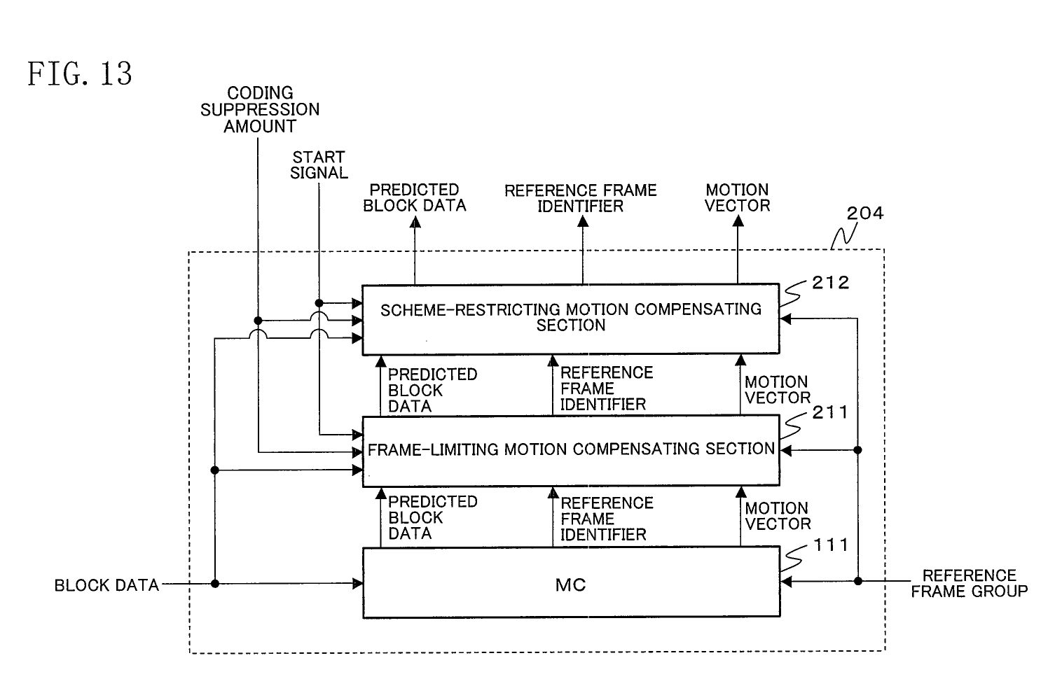

A video coding device 10 in accordance with Embodiment 2 of the present invention is the same as that shown in FIG. 1 except for the internal configuration of the block coding section 14.

<Internal Configuration of Block Coding Section>FIG. 12 shows the internal configuration of the block coding section 14 in the present embodiment. This block coding section 14 includes, in addition to the functional elements shown in FIG. 2, a coding suppression scheme changing section 200, a minor coefficient discarding section 202, and an inter-range coefficient discarding section 203. The block coding section 14 further includes a motion compensation processing section 204 in place of the motion compensating section 111 shown in FIG. 2. The other functional elements are the same as those shown in FIG. 2. FIG. 13 shows the internal configuration of the motion compensation processing section 204 shown in FIG. 12. The motion compensation processing section 204 includes the motion compensating section 111, a flame-limiting motion compensating section 211, and a scheme-restricting motion compensating section 212

<Processing and Effects by Each Functional Element>

Description will be given next to respective processing and effects by the coding suppression scheme changing section 200, the quantization scale correcting section 201, the minor coefficient discarding section 202, the inter-range coefficient discarding section 203, the flame-limiting motion compensating section 211, the scheme-restricting motion compensating section 212.

[Coding Suppression Scheme Changing Section]

The coding suppression scheme changing section 200 receives the suppression determination result from the coding suppression determining section 24 and the coding suppression amount from the coding suppression amount computing section 23

When the suppression determination result is “1” (true), the coding suppression scheme changing section 200 outputs, according to the thus received coding suppression amount, a start signal to (or sets the start signal to “1” in) any one of the quantization scale correcting section 201, the minor coefficient discarding section 202, the inter-range coefficient discarding section 203, the flame-limiting motion compensating section 211, and the scheme-restricting motion compensating section 212. For example, the coding suppression scheme changing section 200 sets the start signal for the quantization scale correcting section 201 to “1” first. When the coding suppression amount becomes large, the coding suppression scheme changing section 200 sets the start signal for the quantization scale correcting section 201 to “0” (stop outputting the start signal) and sets the start signal for the minor coefficient discarding section 202 to “1.” In this way, the coding suppression scheme changing section 200 sets the start signals for the quantization scale correcting section 201, the minor coefficient discarding section 202, the inter-range coefficient discarding section 203, the flame-limiting motion compensating section 211, and the scheme-restricting compensating section 212 to “1” sequentially in this order as the coding suppression amount becomes large.

On the other hand, when the suppression determination result is “0” (false), the coding suppression scheme changing section 200 sets all the start signals to “0.”

By activating any one of the quantization scale correcting section 201, the minor coefficient discarding section 202, the inter-range coefficient discarding section 203, the flame-limiting motion compensating section 211, and the scheme-restricting compensating section 212 according to the coding suppression amount when the coding margin amount is insufficient, precise control of suppression of the coding generation amount can be achieved over a wide range.

[Quantization Scale Correcting Section]

When the start signal from the coding suppression scheme changing section 200 is “1,” the quantization scale correcting section 201 corrects the quantization scale computed by the quantization scale computing section 211 so that the quantization coefficient in the quantization scale is large as the coding suppression amount is large.

On the other hand, when the start signal from the coding suppression scheme changing section 200 is “0,” the quantization scale correcting section 201 adds “0” to the quantization coefficient in the quantization scale from the quantization scale computing section 122, namely, outputs the quantization scale from the quantization scale computing section 112 directly.

[Minor Coefficient Discarding Section]

The minor coefficient discarding section 202 receives the block data quantized by the quantizing section 104, the start signal from the coding suppression scheme changing section 200, and the coding suppression amount from the coding suppression amount computing section 23.

When the start signal from the coding suppression scheme changing section 200 is “1,” the minor coefficient discarding section 202 sets to “0” every coefficient smaller than a discard threshold value out of the coefficients indicated in the block data from the quantization section 104. Further, the minor coefficient discarding section 202 sets the discard threshold value according to the coding suppression amount so that the discard threshold value is large as the coding suppression amount is large.

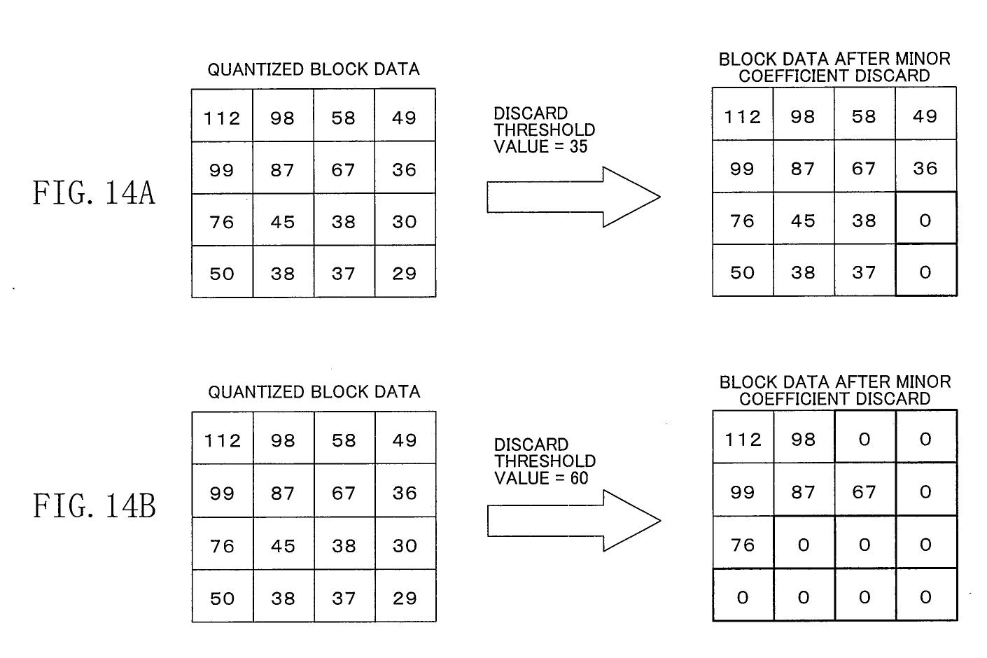

FIG. 14A and FIG. 14B show specific minor coefficient discard performed by the minor coefficient discarding section 202. FIG. 14B shows the case where the coding suppression amount is larger that in the case shown in FIG. 14A. Namely, the discard threshold value is set to “35” so that every coefficient equal to or smaller than “35” is set to “0” in FIG. 14A while the discard threshold value is set to “60” so that every coefficient equal to or smaller than “60” is set to “0” in FIG. 14B.

On the other hand, when the start signal from the coding suppression scheme changing section 200 is “0,” the minor coefficient discarding section 202 outputs the block data from the quantizing section 104 directly without performing the minor coefficient discard.

In this way, every comparatively minor coefficient out of the coefficients indicated in block data is rounded to “0” to reduce degradation in image quality. Further, setting of the discard threshold value according to the coding suppression amount enables precise control of suppression of the coding generation amount. The discard threshold value may be a fixed value.

[Inter-Range Coefficient Discarding Section]

The inter-range coefficient discarding section 203 receives the block data from the minor coefficient discarding section 202, the start signal from the coding suppression scheme changing section 200, and the coding suppression amount from the coding suppression amount computing section 23.

When the start signal from the coding suppression scheme changing section 200 is “1,” the inter-range coefficient discarding section 203 sets each coefficient belonging to a discard range out of the coefficients indicated in the block data from the minor coefficient discarding section 202 to “0.” The inter-range coefficient discarding section 203 sets the discard range according to the coding suppression amount so that the discard range is wide as the coding suppression amount is large.

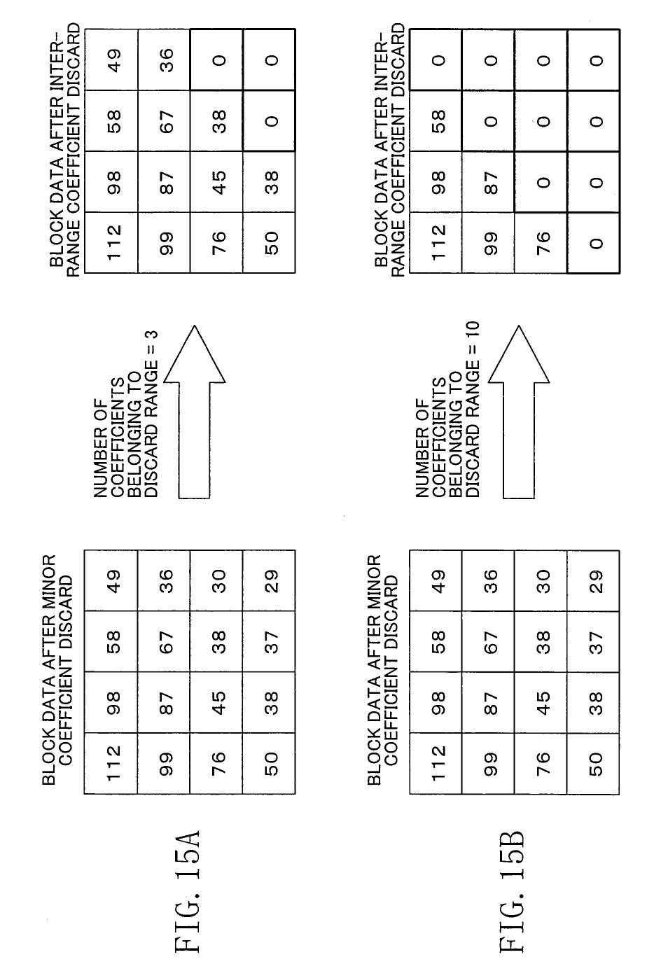

FIG. 15A and FIG. 15B show specific inter-range coefficient discard performed by the inter-range coefficient discarding section 203. FIG. 15B shows the case where the coding suppression amount is larger than that in the case shown in FIG. 15A. Namely, a range to which the three coefficients having higher frequency components belong is set as the discard range to set all the three coefficients to “0” in FIG. 15A while a range to which the ten coefficients having higher frequency components belong is set as the discard range to set all the ten coefficients to “0” in FIG. 15B.

On the other hand, when the start signal from the coding suppression scheme changing section 200 is “0,” the inter-range coefficient discarding section 203 outputs the block data from the minor coefficient discarding section 202 directly to the code string converting section 105 and the inverse quantizing section 106 without performing the inter-range coefficient discard.

By so doing, any coefficient in a high frequency band, which is less observable, out of the coefficients indicated in the block data is set to “0” to permit degradation in image quality to be less observable. In addition, setting of the discard range according to the coding suppression amount achieves precise control of suppression of the coding generation amount. The discard range may be fixed.

[Fame Limiting Motion Compensating Section]

The flame-limiting motion compensating section 211 receives the block data from the block dividing section 13, the reference frame group stored in the frame memory 110, the predicted block data, the motion vector, and the reference frame identifier from the motion compensating section 111, the start signal from the coding suppression scheme changing section 200, and the coding suppression amount from the coding suppression amount computing section 23.

When the start signal from the coding suppression scheme changing section 200 is “1,” the flame-limiting motion compensating section 211 limits the number of usable reference frames so that the number of frames up to a reference frame located the farthest on the time axis from a video frame (to-be-processed frame) including the block data from the block dividing section 211 becomes small out of the reference frames usable in motion compensation. Next, the flame-limiting motion compensating section 211 performs the same processing as that by the motion compensating section 111 with the use of the limited number of reference frames to compute newly a predicted block data, a motion vector, and a reference frame identifier. Then, the flame-limiting motion compensating section 211 outputs the predicted block data, motion vector, and the reference frame identifier thus computed newly rather than the predicted block data, the motion vector, and the reference frame identifier from the motion compensating section 111. Further, the flame-limiting motion compensating section 211 limits the number of usable reference frames according to the coding suppression amount so that the number of usable reference frames is small as the coding suppression amount is large.

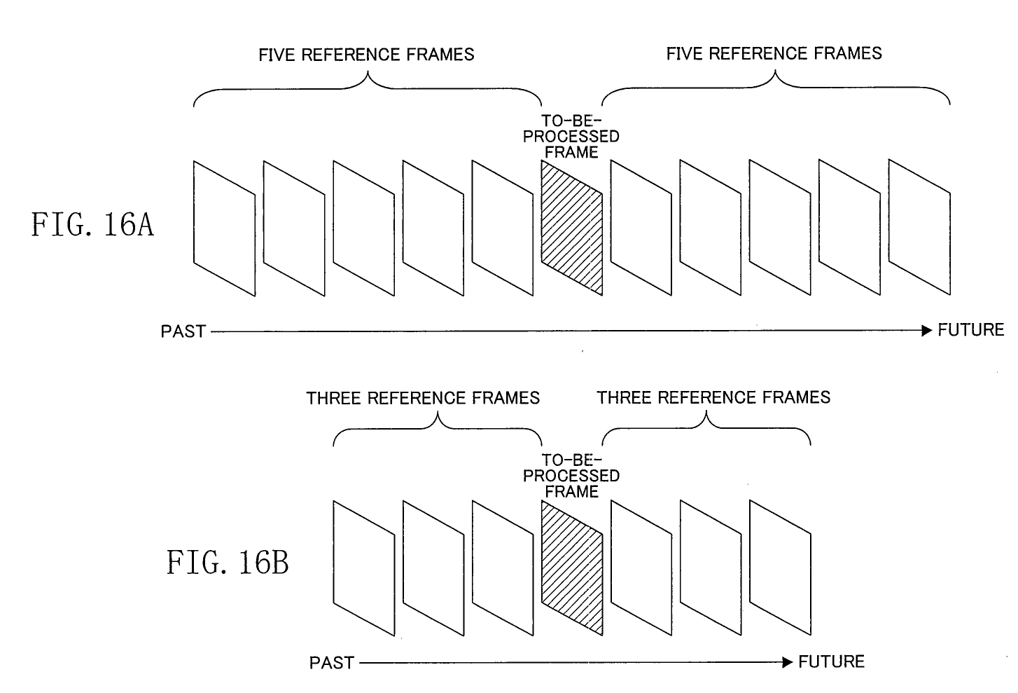

FIG. 16A and FIG. 16B show specific limitation of the number of reference frames performed by the flame-limiting motion compensating section 211. FIG. 16B shows the case where the coding suppression amount is larger than that in the case shown in FIG. 16A. Namely, the number of usable reference frames is limited so that the number of frames up to a reference frame located the farthest on the time axis from the to-be-processed frame is “five” in FIG. 16A while the number of usable reference frames is limited so that the number of frames up to a reference frame located the farthest on the time axis from the to-be-processed frame is “three” in FIG. 16B.

On the other hand, when the start signal from the coding suppression scheme changing section 200 is “0,” the flame-limiting motion compensating section 211 outputs the predicted block data, the motion vector, and the reference frame identifier from the motion compensating section 111 directly.

By so doing, the number of frames up to the reference frame located the farthest from the to-be-processed frame out of the reference frames used in motion compensation becomes small to minimize the coding amount of the reference frame identifier. Further, limitation in the number of usable reference frames according to the coding suppression amount achieves precise control of suppression of the coding generation amount. A fixed value may be used as the number of usable reference frames when the start signal is “1.”

[Scheme-Restricting Motion Compensating Section]

The scheme-restricting motion compensating section 212 receives the block data from the block dividing section 13, the reference frame group stored in the frame memory 110, the predicated block data, the motion vector, and the reference frame identifier from the flame-limiting motion compensating section 211, the start signal from the coding suppression scheme changing section 200, and the coding suppression amount from the coding suppression amount computing section 23.

When the start signal from the coding suppression scheme changing section 200 is “1,” the scheme-restricting motion compensating section 121 restricts referencing schemes usable in motion compensation so that the number of motion vectors computed by the motion compensation becomes small. Then, the scheme-restricting motion compensating section 212 performs the same processing as the motion compensating section 111 in accordance with a restricted referencing scheme to compute newly predicted block data, a motion vector, and a reference frame identifier. Next, the scheme-restricting motion compensating section 212 outputs to the subtractor 101, the code string converting section 105, and the second selector 108 the predicted block data, the motion vector, and the reference frame identifier thus computed newly rather than the predicted block data, the motion vector, and the reference frame identifier from the flame-limiting motion compensating section 211. Further, the scheme-restricting motion compensating section 212 restricts the referencing schemes usable in motion compensation according to the coding suppression amount so that the number of motion vectors to be computed by the motion compensation is small as the coding suppression amount is large.

Specifically, restriction of the referencing schemes by the scheme-restricting motion compensating section 212 is such that, for example, the scheme-restricting motion compensating section 212 does not execute 16-block bidirectional field referencing when the coding suppression amount is smaller than a predetermined threshold value while on the other hand restricts the referencing schemes to only one-block one-way frame referencing when the coding suppression amount is larger than the predetermined threshold value.

On the other hand, when the start signal from the coding suppression scheme changing section 200 is “0,” the scheme-restricting motion compensating section 212 outputs the predicted block data, the motion vector, and the reference frame identifier from the flame-limiting motion compensating section 211 directly to the subtractor 101, the code string converting section 105, and the second selector 108.

In this way, the number of motion vectors and the coding generation amount in the block coding section can be reduced. Further, restriction of the usable referencing schemes according to the coding suppression amount achieves precise control of suppression of the coding generation amount. Referencing schemes usable when the start signal is “1” may be restricted to a predetermined referencing scheme.

In the present embodiment, the coding generation amount in the block coding section 14 is suppressed by activating any one of the quantization scale correcting section 201, the minor coefficient discarding section 202, the inter-range coefficient discarding section 203, the flame-limiting motion compensating section 211, and the scheme-restricting motion compensating section 212, but the coding generation amount may be suppressed by activating some or all of them.

Further, the coding suppression scheme changing section 200 may be omitted in the case where each of the minor coefficient discarding section 202, the inter-range coefficient discarding section 203, the frame-limiting compensating section 211, and the scheme-restricting motion compensating section 212 are configured to operate according to the suppression determination result from the coding suppression determining section 24.

With at least one of the quantization scale correcting section 201, the minor coefficient discarding section 202, the inter-range coefficient discarding section 203, the flame-limiting motion compensating section 211, and the scheme-restricting motion compensating section 212, the coding generation amount in the block coding section 14 can be suppressed.

The referencing schemes used in motion compensation include the field referencing, the frame referencing, the bidirectional referencing, the one-way referencing, and the size variable block referencing in the present embodiment, but not all of them are necessarily employed, or another referencing scheme may be used.

Further, the size variable block referencing includes one-block block referencing to 16-block block referencing in the present embodiment, but the maximum number of blocks may be larger or smaller than 16. Not all the numbers of divided blocks from one to the maximum number may necessarily be used. Three-block block referencing may be not be used, for example.

### Embodiment 3

<Configuration>

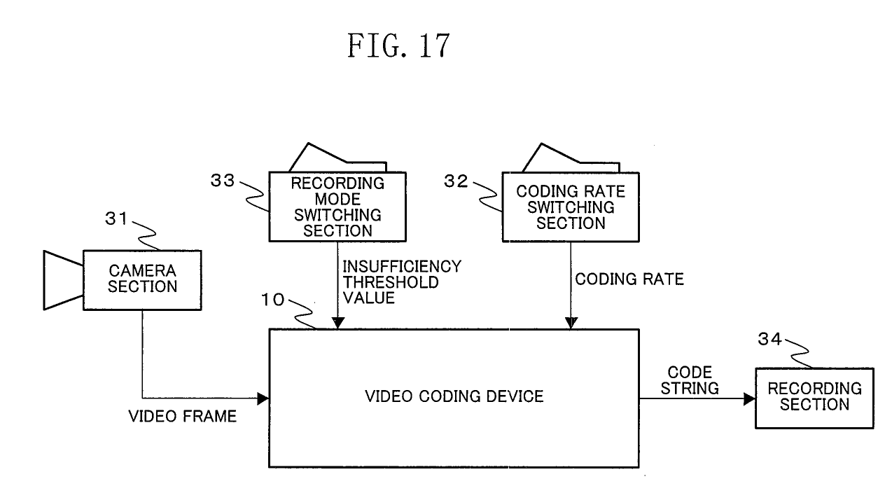

FIG. 17 shows a configuration of a video recording device in accordance with Embodiment 3 of the present invention. This video recording device includes the video coding device 10 shown in FIG. 1, a camera section 31, a coding rate switching section 32, a shooting mode switching section 33, and a recording section 34.

The camera section 31 shoots a dynamic image and outputs an image signal to the video coding device 10.

The coding rate switching section 32 outputs a coding rate specified by the user to the video coding device 10.

The shooting mode switching section 33 outputs an insufficiency threshold value corresponding to a shooting mode specified by the user to the video coding device 10. For example, when the shooting mode is switched to a mode where the coding margin amount is liable to be insufficient, the shooting mode switching section 33 sets the insufficiency threshold value to be large. Such shooting mode switching includes: switching from a natural image shooting mode for shooting a calm scene, such as a landscape to a sport shooting mode for shooting active motion, such as a sport; switching from a low image quality mode to a high image quality mode, a shooting state where the camera is moved vertically or transversely, and the like.

The video coding device 10 receives the image signal from the camera section 31, the coding rate from the coding rate switching section 32, and the insufficiency threshold value from the shooting mode switching section 33 to generate a code string.

The recording section 34 records the code string from the video coding device 10 into a recording medium, such as a CD, a DVD, a Blu-ray-Disc (registered trademark), a HD-DVD, a SD card, a hard disc, or the like.

<Effects>

The video recording device in accordance with the present embodiment can record an image signal in real time and permits degradation in image quality of the image signal to be less observable.

It is noted that the present embodiment describes the case where the video coding device is incorporated in a video camera, but the video coding device is applicable to camera-equipped mobile phones, signal storing and forwarding devices, such as DVD recorders, and the like.

In each of the above embodiments, each of the functional elements included in the video coding device 10 can be reduced to practice through a MPU, a memory, or the like. Each processing by the functional elements can be realized by software (a program) in general, which is recorded in a recoding medium, such as a ROM or the like. Such software may be distributed by software downloading or the like or may be distributed by recording it into a recording medium, such as a CD-ROM or the like. Each functional element can be realized through hardware (a dedicated circuit), of course.

In addition, each processing described in each embodiment may be realized through centralized processing using a single device (a system) or through distributed processing using a plurality of devices. The number of computers for executing the program may be single or plural. In other words, centralized processing or distributed processing may be performed.

As described above, the present invention can achieve control of the coding generation amount so as to satisfy a desired coding rate, permits degradation in image quality of a video fame to be less observable and is, therefore, useful for video cameras, camera incorporated mobile phones, DVD recorders, and the like.

What is claimed is:

1. A video coding device for sequentially coding a plurality of video frames, comprising:
a block dividing section which divides a video frame into plural pieces of block data of a predetermined size and outputs the plural pieces of block data sequentially;
a block coding section which codes the block data from the block dividing section;
a coding amount computing section which computes a coding margin amount on the basis a coding generation amount in the block coding section so that the coding generation amount satisfies a predetermined coding rate;
a coding amount insufficiency determining section which determines whether or not the coding margin amount computed by the coding amount computing section is smaller than an insufficiency threshold value;
a distance computing section which computes a block distance indicating a distance between an arbitrary point of fixation predetermined in the video frame and to-be-processed block data to be processed by the block coding section;
a coding suppression determining section which determines whether or not the block distance computed by the distance computing section is larger than a distance threshold value; and
a coding amount suppressing section which suppresses, when the coding amount insufficiency determining section determines that the coding margin amount is smaller than the insufficiency threshold value and the coding suppression determining section determines that the block distance is larger than the distance threshold value, the coding generation amount in the block coding section according to a coding suppression amount indicating an extent that the coding generation amount is to be suppressed.

2. The video coding device of claim 1, further comprising:
a coding suppression amount computing section which computes the coding suppression amount according to the coding margin amount computed by the coding amount computing section so that the coding suppression amount is large as the coding margin amount is small,
wherein the coding amount suppressing section reduces the coding generation amount in the block coding section as the coding suppression amount computed by the coding suppression amount computing section is large.

3. The video coding device of claim 1, further comprising:
a coding suppression amount computing section which computes the coding suppression amount according to the block distance computed by the distance computing section so that the coding suppression amount is large as the block distance is large,
wherein the coding amount suppressing section reduces the coding generation amount in the block coding section as the coding suppression amount computed by the coding suppression amount computing section is large.

4. The video coding device of claim 1, further comprising:
a picture type information outputting section which outputs picture type information indicating a picture type of the video frame; and
a coding suppression amount computing section which computes the coding suppression amount according to the picture type indicated in the picture type information,
wherein the coding amount suppressing section reduces the coding generation amount in the block coding section as the coding suppression amount computed by the coding suppression amount computing section is large.

5. The video coding device of claim 1,
wherein the coding suppression determining section sets the distance threshold value according to the coding margin amount computed by the coding amount computing section so that the distance threshold value is small as the coding margin amount is small.

6. The video coding device of claim 1, further comprising:
a picture type information outputting section which outputs picture type information indicating a picture type of the video frame,
wherein the coding suppression determining section sets the distance threshold value according to the picture type indicated in the picture type information.

7. The video coding device of claim 1,
wherein the block coding section includes:
an orthogonal transform performing section which performs orthogonal transform on the block data from the block dividing section;
a quantizing section which quantizes, with the use of a quantization scale, the block data subjected to orthogonal transform by the orthogonal transform performing section; and
a code string converting section which converts the block data quantized by the quantizing section to a code string of a fixed length or variable length, and
when the coding amount insufficiency determining section determines that the coding margin amount is smaller than the insufficiency threshold value and the coding suppression determining section determines that the block distance is larger than the distance threshold value, the coding amount suppressing section corrects a quantization coefficient in the quantization scale.

8. The video coding device of claim 7,
wherein the coding amount suppressing section corrects the quantization coefficient in the quantization scale according to the coding suppression amount so that the quantization coefficient in the quantization scale is large as the coding suppression amount is large.

9. The video coding device of claim 1,
wherein the block coding section includes:
an orthogonal transform performing section which performs orthogonal transform on the block data from the block dividing section;
a quantizing section which quantizes the block data subjected to orthogonal transform by the orthogonal transform performing section; and
a code string converting section which converts the block data quantized by the quantizing section to a code string, and
when the coding amount insufficiency determining section determines that the coding margin amount is smaller than the insufficiency threshold value and the coding suppression determining section determines that the block distance is larger than the distance threshold value, the coding amount suppressing section discards every coefficient smaller than a discard threshold value out of a coefficient indicated in the block data from the quantizing section.

10. The video coding device of claim 9,
wherein the coding amount suppressing section sets the discard threshold value according to the coding suppression amount so that the discard threshold value is large as the coding suppression amount is large.

11. The video coding device of claim 1,
wherein the block coding section includes:
an orthogonal transform performing section which performs orthogonal transform on the block data from the block dividing section;
a quantizing section which quantizes the block data subjected to orthogonal transform by the orthogonal transform performing section; and
a code string converting section which converts the block data quantized by the quantizing section to a code string, and
when the coding amount insufficiency determining section determines that the coding margin amount is smaller than the insufficiency threshold value and the coding suppression determining section determines that the block distance is larger than the distance threshold value, the coding amount suppressing section discards every coefficient belonging to a discard range out of a coefficient indicated in the block data from the quantizing section.

12. The video coding device of claim 11,
wherein the coding amount suppressing section sets the discard range to be wide as the coding suppression amount is large.

13. The video coding device of claim 1,
wherein the block coding section includes:
a frame memory which stores a plurality of reference frames;
a motion compensating section which performs motion compensation with the use of the plurality of reference frames stored in the memory frame and the block data from the block dividing section and outputs predicted block data, a motion vector, and a frame reference identifier for identifying a reference frame including the predicted block data;
a subtractor which computes a difference between the predicted block data from the motion compensating section and the block data from the block dividing section and outputs a computation result as predicted error block data,
an orthogonal transform performing section which performs orthogonal transform on the predicted error block data from the subtractor;
a quantizing section which quantizes the predicted error block data subjected to orthogonal transform by the orthogonal transform performing section; and
a code string converting section which converts the predicted error block data quantized by the quantizing section and the motion vector and the reference frame identifier from the motion compensating section to a code string, and
when the coding amount insufficiency determining section determines that the coding margin amount is smaller than the insufficiency threshold value and the coding suppression determining section determines that the block distance is larger than the distance threshold value, the coding amount suppressing section limits the number of usable reference frames.

14. The video coding device of claim 13,
wherein the coding amount suppressing section reduces the number of frames up to a reference frame located the farthest on a time axis from a video frame including the block data from the block dividing section out of reference frames usable in motion compensation as the coding suppression amount is large.

15. The video coding device of claim 1,
wherein the block coding section includes:
a frame memory which stores a plurality of reference frames;
a motion compensating section which performs motion compensation with the use of the plurality of reference frames stored in the frame memory and the block data from the block dividing section and outputs predicted block data, a motion vector, and a frame reference identifier for identifying a reference frame including the predicted block data;
a subtractor which computes a difference between the predicted block data from the motion compensating section and the block data from the block dividing section and outputs a computation result as predicted error block data;
an orthogonal transform performing section which performs orthogonal transform on the predicted error block data from the subtractor;
a quantizing section which quantizes the predicted error block data subjected to orthogonal transform by the orthogonal transform performing section; and
a code string converting section which converts the predicted error block data quantized by the quantizing section and the motion vector and the reference frame identifier from the motion compensating section to a code string, and
when the coding amount insufficiency determining section determines that the coding margin amount is smaller than the insufficiency threshold value and the coding suppression determining section determines that the block distance is larger than the distance threshold value, the coding amount suppressing section restricts referencing schemes usable in motion compensation.

16. The video coding device of claim 15,
wherein the coding amount suppressing section restricts the referencing schemes usable in motion compensation so that the number of motion vectors to be computed through the motion compensation is small as the coding suppression amount is large.

17. The video coding device of claim 2,
wherein the block coding section includes:
a frame memory which stores a plurality of reference frames;
a motion compensating section which performs motion compensation with the use of the plurality of reference frames stored in the frame memory and the block data from the block dividing section and outputs predicted block data, a motion vector, and a frame reference identifier for identifying a reference frame including the predicted block data;
a subtractor which computes a difference between the predicted block data from the motion compensating section and the block data from the block dividing section and outputs a computation result as predicted error block data;
a selecting section which selects one of the block data from the block dividing section and the predicted error block data from the subtractor;
an orthogonal transform performing section which performs orthogonal transform on the block data selected by the selecting section;
a quantizing section which quantizes the block data subjected to orthogonal transform by the orthogonal transform performing section with the use of a quantization scale; and
a code string converting section which converts the block data quantized by the quantizing section and the motion vector and the reference frame identifier from the motion compensating section to a code string, and
the coding amount suppressing section includes:
at least two of: a first processing section for correcting a quantization coefficient indicated in the quantization scale; a second processing section for discarding every coefficient smaller than a discard threshold value out of a coefficient indicated in the block data from the quantizing section; a third processing section for discarding every coefficient belonging to a discard range out of the coefficient indicated in the block data from the quantizing section; a fourth processing section for limiting the number of reference frames usable in motion compensation; and a fifth processing section for restricting referencing schemes used in motion compensation; and
a suppression scheme changing section which changes, when the coding amount insufficiency determining section determines that the coding margin amount is smaller than the insufficiency threshold value and the coding suppression determining section determines that the block distance is larger than the distance threshold value, each driving state of the processing sections according to the coding suppression amount computed by the coding amount computing section.

18. The video coding device of claim 1,
wherein the predetermined arbitrary point of fixation is the center of the video frame.

19. A video recording device, comprising:
a video coding device according to claim 1;
an input section which provides the video frame to the video coding device; and
a recording section which records the code string from the video coding device to a recording medium.

20. A method for sequentially coding a plurality of video frames, comprising the steps of:
(a) dividing a video frame into plural pieces of block data of a predetermined size;
(b) outputting any one of the plural pieces of block data generated in the step (a);
(c) coding the block data output in the step (b);
(d) computing a coding margin amount on the basis of a coding generation amount in the step (c) so that the coding generation amount satisfies a desired coding rate;
(e) determining whether or not the coding margin amount computed in the step (d) is smaller than an insufficiency threshold value;
(f) outputting to-be-coded block data out of the plural pieces of block data generated in the step (a);
(g) computing a block distance indicating a distance between an arbitrary point of fixation predetermined in the video frame and the block data output in the step (f);
(h) determining whether or not the block distance computed in the step (g) is larger than a distance threshold value; and
(i) performing, when it is determined in the step (e) that the coding margin amount is smaller than the insufficiency threshold value and it is determined in the step (h) that the block distance is larger than the distance threshold value, processing for suppressing the coding generation amount and then coding the block data output in the step (f).

21. A video coding program which allows a computer to execute a video coding method according to claim 20.
